(19) United States
(12) Patent Application Publication
(10) Pub. No.: US 2025/0123196 A1
(43) Pub. Date: Apr. 17, 2025

(54) ATMOSPHERIC RESISTIVE CORROSION SENSING

(71) Applicant: AtmosphericlQ LLC, Evanston, IL (US)

(72) Inventors: Thomas Hayden, Evanston, IL (US); Joesphan Lu, Phoenix, AZ (US); Joseph Mazzella, Evanston, IL (US)

(21) Appl. No.: 18/915,023

(22) Filed: Oct. 14, 2024

Related U.S. Application Data
(60) Provisional application No. 63/589,819, filed on Oct. 12, 2023.

(51) Int. Cl. G01N 17/04; G01N 17/00; G01N 17/02

(52) U.S. Cl. CPC G01N 17/046; G01N 17/006; G01N 17/02

(57) ABSTRACT

An atmospheric corrosion sensing electrode is configured for sensing atmospheric corrosion through changes in the resistance of a sample material on the electrode. The electrode is configured to removably connect with a data logger or other instrumentation. The electrode includes a corrosion circuit with first and second legs in parallel. The first leg includes first and second resistive components connected in series, and the second leg includes a third resistive component and a sample material in series. The electrode has a protective coating overlaying the first, second, and third resistive components but not the sample material. At least one electrical connector is configured to connect the corrosion sensing electrode to a data logger. An atmospheric corrosion sensor includes a data logger connected with an atmospheric corrosion sensing electrode. The data logger is configured to determine changes in atmospheric corrosion based on changes in a resistance of the electrode.

### CROSS-REFERENCE TO RELATED APPLICATION(S)

This application claims the benefit under 35 U.S.C. § 119 (e) to U.S. Provisional Application U.S. 63/589,819, filed Oct. 12, 2023, and entitled “Atmospheric Resistive Corrosion Sensing,” which is hereby incorporated herein by reference in its entirety.

### TECHNICAL FIELD

The disclosed technology generally relates to sensing corrosion of various materials and more particularly relates to measuring corrosion of metals in various atmospheric conditions.

### BACKGROUND

The United States has over 2.2 million kilometers of pipelines, the majority of which transport oil and natural gas. Corrosion is the leading cause of pipeline failures and can cause extensive damage to the pipeline and its surrounding environment. About 60% of pipeline incidents are caused by corrosion. Corrosion is a serious problem for the oil and gas industry because it can significantly reduce the integrity of pipelines, leading to a variety of issues such as leaks, spills, and explosions. Corrosion can cause pipelines to become structurally weak, which can lead to pipe failure and the release of hazardous materials. Moreover, corrosion can also lead to increased costs due to the need to replace pipelines and clean up any spills. Pipeline corrosion costs the oil and gas industry billions of dollars every year in lost revenue and repair costs. Corrosion is responsible for roughly 3.4% of the global GDP, estimated by the International Measures of Prevention, Application and Economics of Corrosion Technology (IMPACT) study.

In order to reduce the risk and cost of corrosion, pipeline operators rely on corrosion mitigation strategies. Corrosion sensors allow oil and gas companies to monitor corrosion on their pipelines before it becomes a serious problem. Electrical Resistance (ER) probes are often used to measure below-ground corrosion. ER probes typically monitor the electrical resistance of an exposed “coupon” of the same metal, e.g., a steel coupon for a steel pipeline. Generally speaking, increases in the probe's electrical resistance are often assumed to indicate the presence of corrosion on the coupon and, by extension, the underground pipeline.

Determining above ground, or atmospheric, corrosion typically involves complex alternating current (AC) impedance measurements. Such measurements are sensitive to environmental factors and require complex and expensive integrated circuits. These and other issues indicate a need for improved systems, devices and methods for measuring corrosion.

### BRIEF SUMMARY

Aspects of the disclosed technology provide devices and methods for determining atmospheric corrosion of materials. Various aspects including implementations of an atmospheric corrosion sensing electrode, an atmospheric corrosion sensor, and the systems and methods included therein are disclosed.

According to Example 1, an atmospheric corrosion sensing electrode is disclosed. The electrode is configured to removably connect with a data logger, the electrode comprising a corrosion circuit comprising a first leg comprising a first resistive component and a second resistive component in series, and a second leg comprising a third resistive component and a sample material in series, the second leg parallel with the first leg, a protective coating overlaying the first, second and third resistive components but not the sample material, and at least one electrical connector configured to connect the corrosion sensing electrode to a data logger.

In Example 2, the electrode of Example 1, further comprising a printed circuit board, wherein each of the first, second, and third resistive components and the sample material comprises a conductive trace on the printed circuit board.

In Example 3, the electrode of Example 2, wherein the conductive trace of each of the first, second, and third resistive components and the sample material comprises a winding, interdigitated shape.

In Example 4, the electrode of Example 3, wherein each of the first, second, and third resistive components and the sample material comprises the same shape.

In Example 5, the electrode of Example 4, wherein the first and second resistive components are symmetrically arranged with the third resistive component and the sample material, respectively, about a first line, and wherein the first and third resistive components are symmetrically arranged with the second resistive component and the sample material, respectively, about a second line perpendicular to the first line.

In Example 6, the electrode of Example 1, wherein the sample material comprises steel.

In Example 7, the electrode of Example 1, wherein the at least one electrical connector comprises a plurality of conductors comprising a first conductor electrically coupled to the first and third resistive components, a second conductor electrically coupled to second resistive component and the sample material a third conductor electrically coupled to the first leg between the sample material and the third resistive component and a fourth conductor electrically coupled to the second leg between the first resistive component and the third resistive component.

In Example 8, the electrode of Example 1, wherein the at least one electrical connector comprises a plurality of connectors comprising a first connector electrically coupled to the first and third resistive components, a second connector electrically coupled to second resistive component and the sample material, and a third connector comprising first and second conductors, the first conductor electrically coupled to the first leg between the sample material and the third resistive component, and the second conductor electrically coupled to the second leg between the first resistive component and the third resistive component.

In Example 9, the electrode of Example 1, wherein the corrosion circuit comprises a Wheatstone bridge.

In Example 10, the electrode of Example 1, wherein the corrosion circuit consists essentially of a Wheatstone bridge.

In Example 11, the electrode of Example 1, wherein the corrosion circuit consists of a Wheatstone bridge.

In Example 12, an atmospheric corrosion sensor comprising a data logger comprising an electrical connector and sensing circuitry, and an atmospheric corrosion sensing electrode comprising a corrosion circuit comprising a first leg comprising a first resistive component and a second resistive component in series, and a second leg comprising a third resistive component and a sample material in series, the second leg parallel with the first leg, a protective coating overlaying the first, second and third resistive components but not the sample material, and at least one electrical connector configured to connect the corrosion sensing electrode to the electrical connector of the data logger thereby connecting the corrosion circuit to the sensing circuitry.

In Example 13, the corrosion sensor of Example 12, wherein the sensing circuitry is configured to measure a voltage across the first leg and the second leg and determine a change in corrosion of the sample material based on the measured voltage.

In Example 14, the electrode of Example 12, further comprising a printed circuit board, wherein each of the first, second, and third resistive components and the sample material comprises a conductive trace on the printed circuit board.

In Example 15, the electrode of Example 14, wherein the conductive trace of each of the first, second, and third resistive components and the sample material comprises a winding, interdigitated shape.

In Example 16, the electrode of Example 15, wherein each of the first, second, and third resistive components and the sample material comprises the same shape.

In Example 17, the electrode of Example 16, wherein the first and second resistive components are symmetrically arranged with the third resistive component and the sample material, respectively, about a first line, and wherein the first and third resistive components are symmetrically arranged with the second resistive component and the sample material, respectively, about a second line perpendicular to the first line.

In Example 18, the corrosion sensor of Example 12, wherein the sample material comprises steel.

In Example 19, the corrosion sensor of Example 12, wherein the at least one electrical connector of the atmospheric corrosion sensing electrode comprises a plurality of conductors comprising a first conductor electrically coupled to the first and third resistive components, a second conductor electrically coupled to second resistive component and the sample material; a third conductor electrically coupled to the first leg between the sample material and the third resistive component; and a fourth conductor electrically coupled to the second leg between the first resistive component and the third resistive component.

In Example 20, the corrosion sensor of Example 12, wherein the corrosion circuit comprises a Wheatstone bridge.

Implementations of the described techniques may include hardware, a method or process, or computer software on a computer-accessible medium. As an example, a data logger and/or sensing circuitry can include a system of one or more computers that can be configured to perform particular operations or actions by virtue of having software, firmware, hardware, or a combination of them installed on the system that in operation causes or cause the system to perform the actions. One example includes using resistance measurements of the sample material to determine changes in corrosion of the sample material. One or more computer programs can be configured to perform this and other particular operations or actions by virtue of including instructions that, when executed by data processing apparatus, cause the apparatus to perform the actions.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic representation of a corrosion sensing electrode according to an implementation.

FIG. 2 is an illustration of an atmospheric corrosion sensor according to an implementation.

FIG. 3 is an illustration of an atmospheric corrosion sensor according to an implementation.

FIG. 4 is a partial printed circuit board (PCB) layout for a corrosion sensing electrode according to an implementation.

FIG. 5 is an illustration of a corrosion sensing electrode prior to attaching connectors, according to an implementation.

FIG. 6 is a depiction of a corrosion sensing electrode prior to attaching connectors according to an implementation.

FIG. 6 is a depiction of a corrosion sensing electrode with attached connectors according to an implementation.

FIGS. 7-9 are PCB layouts for a corrosion sensing electrode according to various implementations.

FIG. 10 is a circuit diagram for a corrosion sensing electrode according to an implementation.

FIGS. 11-15 are diagrams of various circuits for driving a corrosion sensing electrode and measuring corrosion of the electrode according to an implementation.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### DETAILED DESCRIPTION

The disclosed technology includes devices and methods for measuring atmospheric, or above-ground, corrosion of materials. According to one aspect, the disclosed technology is directed to methods and circuits for determining corrosion of various materials above-ground. Implementations include measuring the electrical resistance of an exposed sample material in order to determine mass loss due to atmospheric corrosion. In various cases the sample material is a metal or metal alloy including, for example, steel, copper, and aluminum. For convenience, the exposed sample material is at times alternatively referred to herein as a “coupon” and an “electrode.”

Another aspect of the disclosed technology involves a corrosion sensor for determining atmospheric corrosion. The atmospheric corrosion sensor includes a data logger with sensing circuitry electrically coupled with a removable corrosion sensing electrode. In various implementations the sensing electrode includes an exposed material sample that forms part of a resistive bridge circuit. The bridge circuit is used to determine a changing resistance of the sample that corresponds to corrosion of the sample. The exposed sample can have a variety of configurations, shapes, and/or compositions. In various implementations the exposed sample is shaped as a winding trace of a material such as a metal or metal alloy including, for example, steel, copper, and aluminum. One possible configuration that will be discussed herein includes a winding trace with interdigitated loops formed on a printed circuit board.

According to various implementations, the disclosed technology incorporates a measurement method that uses a resistive bridge network for measuring electrical resistance. For convenience, electrical resistance or “ER” is simply referred to herein as “resistance.” In various cases the resistive bridge network is a Wheatstone bridge. This process advantageously makes the sensor unsusceptible to temperature and humidity changes. Incorporating a resistive bridge circuit also simplifies operation since voltage supply and measurement involve direct current (DC).

Currently available atmospheric corrosion sensors in the market typically employ alternating current (AC) based impedance electrodes and measurement tools. Various implementations of the disclosed technology include a corrosion sensor that is an improvement over current ER corrosion probes that involve AC impedance measurements. As an example, in various implementations the corrosion sensor measures DC, which is far less complicated and less sensitive to environmental factors than AC impedance but just as effective at detecting corrosion. Various implementations also include a sensor and/or sensing electrode that is less complicated to construct, with the resulting measurements being more accurate than complicated designs of existing corrosion sensors.

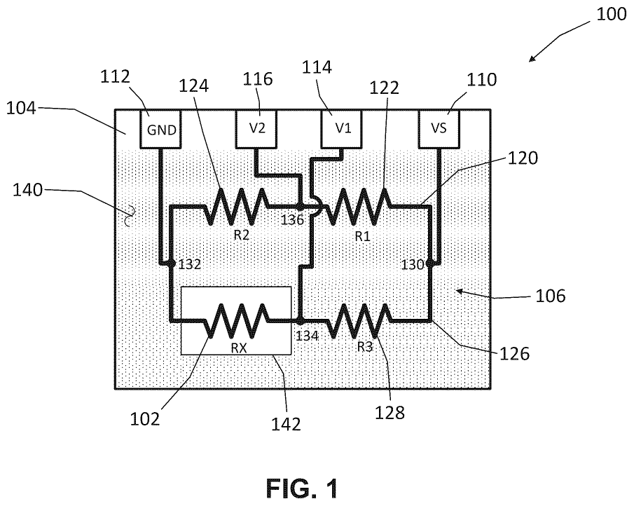

FIG. 1 is a schematic representation of an atmospheric corrosion sensing electrode 100 according to an implementation. The sensing electrode 100 is configured for measuring atmospheric corrosion of a sample material 102 (e.g., placed on or forming part of the electrode) using a mass loss resistance-based approach. In various implementations the sensing electrode includes a PCB 104 with one or more electrical components that form a corrosion circuit 106 including the sample material 102. The sensing electrode also includes one or more connectors that are configured to connect the corrosion circuit to a data logger for driving the corrosion circuit and reading the signals produced by the corrosion circuit. As shown in FIG. 1, in various cases the sensing electrode 100 includes a supply connector 110, a ground connector 112, and two measurement connectors 114, 116, which are all schematically and abstractly depicted. One or more other connectors may be included for various other signals depending upon the particular implementation.

Continuing with FIG. 1, in various cases the sample material 102 has an unknown electrical resistance Rₓ that forms part of the electrical circuit (sometimes referred to herein as a “corrosion circuit”) on the sensing electrode 100. In various cases the sample material 102 is a metal or alloy such as copper, aluminum, steel, gold, silver, etc. As the sample material 102 corrodes, the material converts into an oxide which has very poor conductivity. In various cases the corrosion sensor detects and measures the oxidation or corrosion by measuring the electrical resistance Rₓ of the corroded material.

According to various implementations, the corrosion circuit 106 is a resistive bridge circuit. As shown in FIG. 1, in this example the resistive bridge circuit is a Wheatstone bridge that can measure very small changes in resistance. The corrosion circuit 106 has first and second legs 120, 126, respectively, that extend in parallel between a first node 130 connected to the supply connector 110 and a second node 132 connected to the ground connector 112. The first leg 120 includes a first resistive component 122 in series with a second resistive component 124, with resistances R₁ and R₂, respectively. The second leg 126 includes a third resistive component 128 with a resistance R₃ in series with the sample material 102. According to various implementations, the unknown resistance Rₓ of the sample material can be determined by applying a supply voltage V_{S} to the supply connector 110 and using the first and second measurement connectors 114, 116 to measure a voltage V₁ at a third node 134 and a voltage V₂ at a fourth node 136.

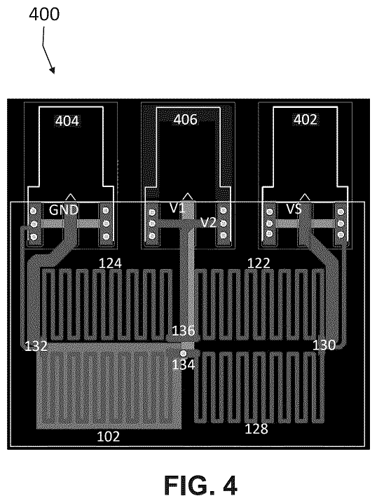

In various cases the first, second, and third resistive components 122, 124, 126, and the sample material 102 (alternatively considered a “fourth resistive component”) are coils or windings made out of the type of material (e.g., metal) that is being monitored for corrosion. As an example, in various cases a sensor to monitor corrosion in steel has the first, second, and third resistive components 122, 124, 126, respectively, and the sample material 102 made out of steel. As another example, a sensor used to monitor copper corrosion has the first, second, and third resistive components and the sample material made from copper. As shown in FIGS. 4-10, in various implementations the resistive components and/or the sample material are formed from conductive traces that loop back and forth multiple times to make an interdigitated pattern on the PCB. In various implementations, each of the resistive components 122, 124, 126 and the sample material 102 is similar to or incorporates a strain gauge. In various alternative implementations, the first, second, and third resistive components may have a different configuration from the sample material as long as the resistive components have equivalent resistances to the sample material. For example, in some cases the first, second, and third resistive components could be discrete resistors or configured in another manner such that they have the same resistance as the sample material.

Returning to FIG. 1, in various cases the first, second, and third resistive components 122, 124, 126, are covered with a protective coating 140. In some cases the protective coating is a solder mask, such as a thin layer of polymer that is applied to copper traces of a PCB for protection against oxidation. According to various implementations, the coating 140 prevents the three resistive components 122, 124, 126 from corroding. The sample material 102 is left uncoated. As shown in FIG. 1, in various implementations an opening e in the coating 140 exposes the sample material 102 to ambient external conditions so that it may corrode over time.

In various cases the sensing circuitry within the data logger includes a DC battery that provides a current through the corrosion circuit 106 on the sensing electrode 100. Initially, the resistances R₁, R₂, R₃, and Rₓ are the same and the corrosion circuit 106 is balanced so that the voltages V₁ and V₂ at the third and fourth nodes 134, 136 are the same. Since the first, second, and third resistive components 122, 124, 126 are protected with the coating 140 (e.g., solder mask), they will not corrode. When the exposed sample material 102 begins to corrode, the circuit 106 becomes unbalanced and the difference between V₁ and V₂ can be measured to determine Rₓ. The amount or rate of corrosion can then be determined based on changes in Rₓ.

The resistance of a strip of material can be calculated based on its dimensions. As an example, the resistance of a length of a copper strip can be determined based on the strip's length, cross-sectional area, and the resistivity of the material. The resistance can generally be determined as follows:

$${R}_{X} = ρ ( \frac{L}{A} ) [ 1 + α ( {T}_{a m b} - {T}_{ref} ) ]$$

where:
ρ=resistivity at T_{ref} (e.g., 1.7×10⁻⁶ ohm-cm for copper at T_{ref}=20° C.)
α=Temperature Coefficient of Resistance (TCR)
T_{ref}=reference temperature
T_{amb}=ambient or operating temperature
L=length
A=cross-sectional area

The cross-sectional area A of a PCB trace is typically rectangular or trapezoidal. In either case, the above equation can be rearranged to show that the resistance R is inversely proportional to trace height T, which corresponds to the amount of trace material that has not been oxidized or corroded. For example, the resistance of a rectangular cross-section can be determined as:

$${R}_{X} = \frac{1}{T} ( ρ \frac{L}{W} ) [ 1 + α ( {T}_{a m b} - {T}_{ref} ) ]$$

$$where :$$

$${A}_{r e c} = T \times W$$

Accordingly, measuring the voltage difference between the third and fourth nodes 134, 136 and determining Rₓ provides an indication of the current trace height. In various implementations the corrosion sensor is configured to determine the voltage difference and/or resistance and/or trace height in order to determine a current amount of corrosion. In various cases the corrosion sensor is also configured to monitor the voltage difference and/or resistance and/or trace height over time in order to determine a rate of corrosion. According to various implementations, the corrosion sensor may determine one or more of the voltage difference, resistance, and trace height and then determine an amount of corrosion or mass loss using a theoretical or empirical correlation.

In various implementations the corrosion sensor is configured to determine Rₓ based on the voltage difference V₁-V₂. Initially, R₁=R₂=R₃=Rₓ and the relationship between V₁, V₂, and Rₓ can be expressed as follows:

$${V}_{12} = {V}_{1} - {V}_{2}$$

$${V}_{12} = \frac{{R}_{x}}{{R}_{3} + {R}_{x}} {V}_{S} - \frac{{R}_{2}}{{R}_{1} + {R}_{2}} {V}_{S}$$

$${V}_{12} = \frac{{R}_{x}}{{R}_{3} + {R}_{x}} {V}_{S} - \frac{1}{2} {V}_{S}$$

From these relationships it will be appreciated that Rₓ increases as corrosion increases and the trace height T decreases. At the limits, Rₓ increases to infinity (i.e., an open circuit) as the trace height T decreases to zero. As this happens, V₁₂ approaches one half of VS:

$${V}_{12} = \frac{∞}{{R}_{3} + ∞} {V}_{S} - \frac{1}{2} {V}_{S}$$

$${V}_{12} \approx {V}_{S} - \frac{1}{2} {V}_{S} = \frac{1}{2} {V}_{S}$$

Since the resistances of the first, second, and third resistive components 122, 124, 126 and the resistance of the sample material 102 are initially the same, the corrosion circuit 106 will initially be balanced and the voltage across the output V₁-V₂ will initially be zero. As the sample material 102 etches away, Rₓ increases and V₁₂ of the Wheatstone bridge approaches 0.5*V_{S}. As an example, if V_{S}=10 mV, V₁₂ will approach 5 mV as Rₓ increases toward infinity, which corresponds to the trace for the sample material 102 etching away to form an open circuit.

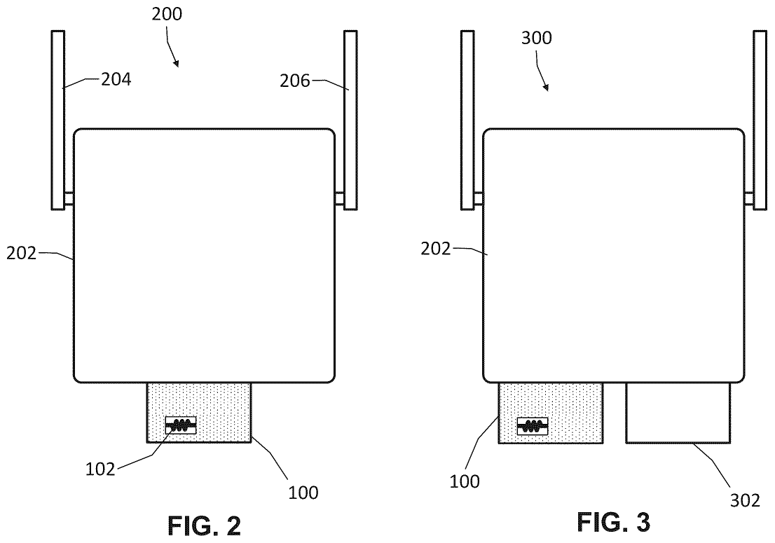

FIG. 2 is an illustration of an atmospheric corrosion sensor 200 according to various implementations. The corrosion sensor 200 includes a data logger 202 with a connected and removable corrosion sensing electrode 100. In various cases the corrosion sensor 200 is configured to be removably mounted or attached to a variety of structures for sensing in a desired location with particular atmospheric conditions. According to various implementations, the data logger 202 includes circuitry that is configured to drive the corrosion sensing electrode 100, read the output of the sensing electrode, and determine an amount of atmospheric corrosion of the sample material 102 on the sensing electrode. In various cases the corrosion sensor 200 is configured to repeatedly execute these steps to determine a rate of atmospheric corrosion of the sample material 102 over time. In some cases the corrosion sensor 200 may simply read and log the sensing electrode 100 output and/or transmit card output signals for further processing at another location.

In addition to being configured to drive and read the corrosion sensing electrode 100, the data logger 202 can be configured with a variety of additional features and capabilities known to those skilled in the art. The example of FIG. 2 includes dual antennae 204, 206 that enables the data logger 202 to wirelessly transmit information (e.g., sensing electrode output values) to another location. In various implementations the corrosion sensor 200 is an Internet of Things (IoT) device. According to various implementations the data logger 200 includes capabilities similar to the CBOT™ atmospheric sensor available from Engineering Director, Inc. of Evanston, IL.

FIG. 3 is an illustration of another atmospheric corrosion sensor 300 according to various implementations. In this example, the atmospheric corrosion sensor 300 is similar to the corrosion sensor 200 shown in FIG. 2. In addition to the corrosion sensing electrode 100 of FIG. 2, the corrosion sensor 300 in FIG. 3 also includes a traditional atmospheric AC impedance sensing electrode 302 (shown on the right).

Including different types of sensor circuits can be advantageous in various cases since the use of different corrosion sensing technologies can enable comparisons, checks, and alternatives in various cases.

Referring to FIGS. 2 and 3, the corrosion sensing electrode 100 can be connected to the data logger 202 in a variety of suitable ways. According to various implementations, connectors with very low resistance are used in order to limit any effect on the measurements of the sensing electrode 100. In various implementations the sensing electrode 100 includes one or more connectors that are configured to physically and removably connect the sensing electrode 100 to the data logger 202. The connector(s) are also configured to electrically couple the circuitry on the sensing electrode to one or more sensor circuits within the data logger. In various cases the connectors provide at least four electrical connections, including one for each of the supply voltage V_{S}, ground GND, the voltage V₁ at the first node 130, and the voltage V₂ at the second node 132. In some cases the connections may be provided through a single, multi-conductor connector. In some cases the connections may be split among two or more connectors. In various cases a separate connector is included for each signal V_{S}, GND, V₁, and V₂.

A variety of connector types can be used depending upon a particular implementation. In various cases surface-mount connectors are used to facilitate attaching the connectors to the sensing electrode PCB 104 and a PCB within the data logger. Some examples of possible connector types include, but are not limited to, RF or coaxial connectors, edge connectors, XLR connectors, USB connectors, and others. According to various implementations, connectors with very low contact resistance can be used to limit effects on the measurements of the sensing electrode 100. In some cases, actual resistance values for R₁, R₂, R₃, and Rₓ can be in the milliohm range. In some cases the resistance value for these components is about 0.139 ohms. An SMA connector is one type of low contact resistance connector used in various implementations. In various implementations SMA connectors with contact resistances of 2-3 milliohms are used.

FIG. 4 is a partial layout 400 of a printed circuit board for one possible implementation of the atmospheric corrosion sensing electrode 100 shown in FIG. 1. The layout 400 illustrates the relative placement of the first, second, and third resistive components 122, 124, 126 and the sample material 102. The resistive components and the sample material are designed identically (e.g., within manufacturing tolerances) in this example so as to have virtually identical resistances. As shown in FIG. 4, in this example the resistive components 122, 124, 126 and the sample material 102 have the shape of multiple windings or loops that form an interdigitated pattern on the PCB. In various implementations the resistive components and sample material are similar to or incorporates a strain gauge.

The resistive components and sample material are coupled together in a bridge circuit, which in this case is a Wheatstone bridge circuit. The first and second resistive components 122, 124 are coupled together at the fourth node 136, in series between the first and second nodes 130, 132. The third resistive component 128 and the sample material 102 are coupled in series at the third node 134 between the first and second nodes and in parallel with the first and second resistive components 122, 124.

FIG. 4 also illustrates the location of multiple connectors (illustrated in outline) and pads for attaching the connectors to the sensing electrode. In particular, pads for a supply jack 402 are connected to the first node 130 and pads for a ground jack 404 are connected to the second node 132. A first pad for a measurement jack 406 is connected to the third node 134 and a second pad for the measurement jack 406 (e.g., on the underside of the board) is connected to the fourth node 136.

As indicated in outline in FIG. 4, and shown in later figures, jacks 402, 404, and 406 are implemented in various cases as SMA connectors. In the illustrated example, the separate supply and ground connectors 402, 404 are used for the supply voltage V_{S} and the ground signal GND, respectively, and multiple contacts of the single measurement connector 406 are used for measuring the voltages V₁ and V₂.

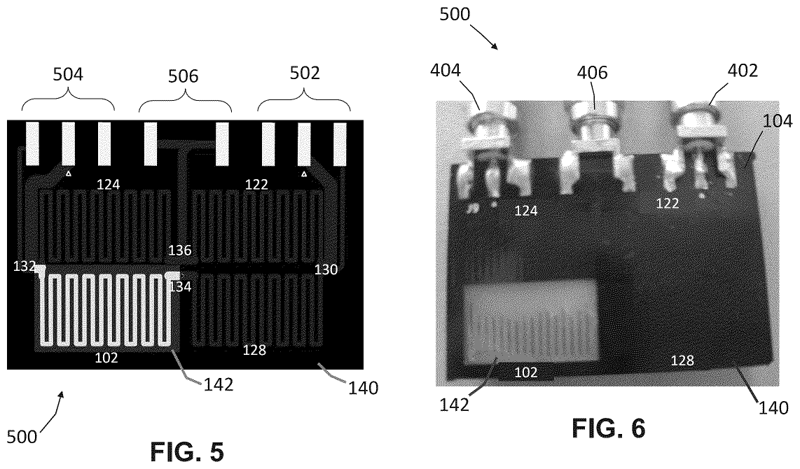

FIG. 5 is a schematic diagram of a corrosion sensing electrode 500 according to various implementations. The sensing electrode 500 corresponds to the layout 400 of FIG. 4 and depicts the electrode prior to attaching connectors. As can be seen in this figure, the corrosion sensing electrode 500 includes a first group of pads 502 for the supply jack, a second group of pads 504 for the ground jack, and a third group of pads 506 for the measurement jack. Although not shown, the third group of pads 506 also includes a pad on the opposite side of the PCB that connects to the third node 134. In addition, resistive windings are deposited according to the layout 400 in FIG. 4 to form the first, second, and third resistive components 122, 124, 126 and the sample material 102. A protective coating in the form of a solder mask 140 is deposited over the first, second, and third resistive components 122, 124, 126, but not over the sample material 102, which is left exposed through the window 142 in the mask 140. In various implementations the exposed sample and other resistive components are formed from a material such as a metal or metal alloy including, for example, copper, silver, gold, aluminum, or another metal. In various cases the material is steel. One example of steel that is used in various implementations is Grade 1018 steel.

FIG. 6 is another depiction of the corrosion sensing electrode 500 of FIG. 5 according to various implementations. In this example, the supply jack 402, the ground jack 404, and the measurement jack 406 are shown soldered to the PCB 104 according to the layout 400 of FIG. 4. The sample material 102 is exposed through the mask opening 142, while the first, second, and third resistive components 122, 124, 126 are covered by the mask 140. FIG. 6 also illustrates corrosion and deterioration of the sample material 102 according to various implementations. When compared with FIG. 5, it can be seen that portions of the sample material 102 shown in FIG. 5 are missing from the depiction in FIG. 6, due to corrosion of the material. As previously discussed, sensing circuitry (e.g., in an attached data logger) can be used to measure changes in the resistance of the sample material to detect atmospheric corrosion according to various implementations.

In various implementations the components and/or electrical connections of the atmospheric corrosion sensing electrode are arranged in order to minimize differences in the measurement of the voltages V₁ and V₂ of the parallel voltage dividers created by the resistive components and the sample material. For example, in various implementations the resistive components and the sample material have a symmetrical arrangement, or nearly a symmetrical arrangement. As shown in FIGS. 5 and 6, the resistive components 122, 124, 126 and the sample material 102 of the sensing electrode 500 are all formed as identical, interdigitated patterns and are located opposite horizontal and vertical lines of symmetry on the PCB 104.

In some cases the electrical connections between the resistive components, sample material, and connectors also have a symmetrical arrangement or nearly a symmetrical arrangement. In some cases the placement of the connectors may also be symmetrical. Referring to FIGS. 5 and 6, the same traces provide the voltage supply V_{S} and ground GND connections to each leg of the corrosion circuit at the first and second nodes 130, 132. Referring to FIG. 4, it will be appreciated that the traces connecting the first and second nodes 130, 132 to the pads of the measurement connector 406 have nearly the same lengths. Such arrangements can eliminate or reduce the relative effect of parasitic resistances from the trace connections, thus leading to more accurate voltage measurements and a more accurate measurement of the unknown resistance Rₓ of the sample material 102.

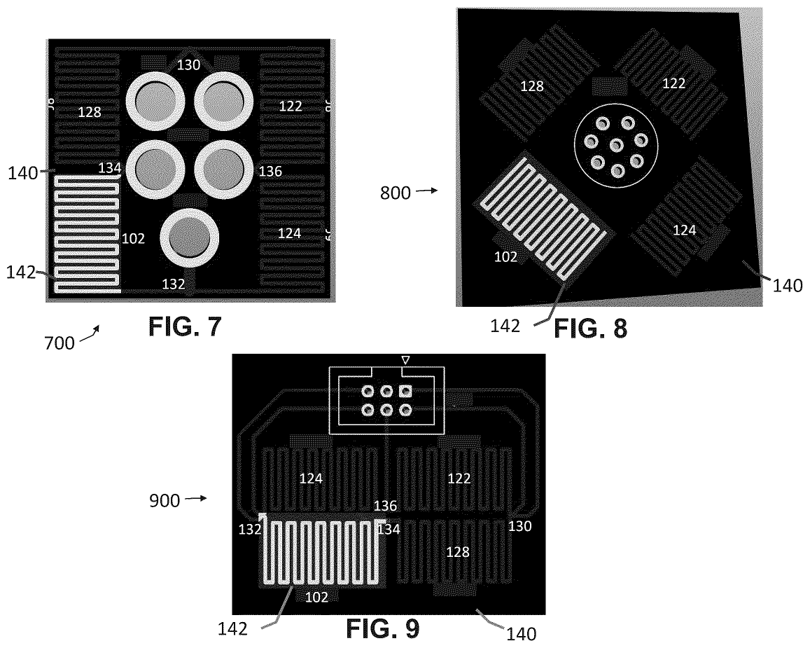

FIGS. 4-6 illustrate one possible example for the configuration and layout of the resistive components, sample material, connectors, and traces of the illustrated atmospheric corrosion sensing electrode 500. It should be appreciated that the corrosion sensing electrode can use a variety of alternative layouts, configurations, and collections of electrical components in various implementations. FIGS. 7-9 illustrate a few of the potential alternative layouts available for corrosion sensing electrodes in accordance with the disclosed technology. Other layouts and configurations are also possible.

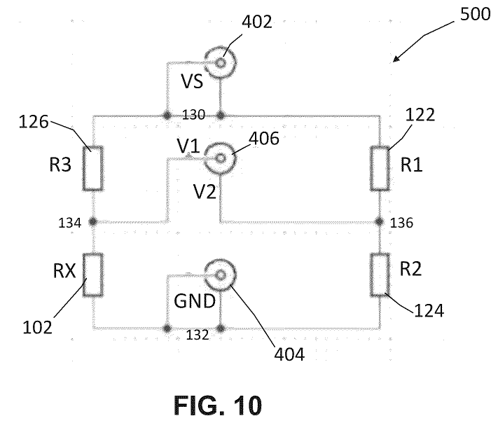

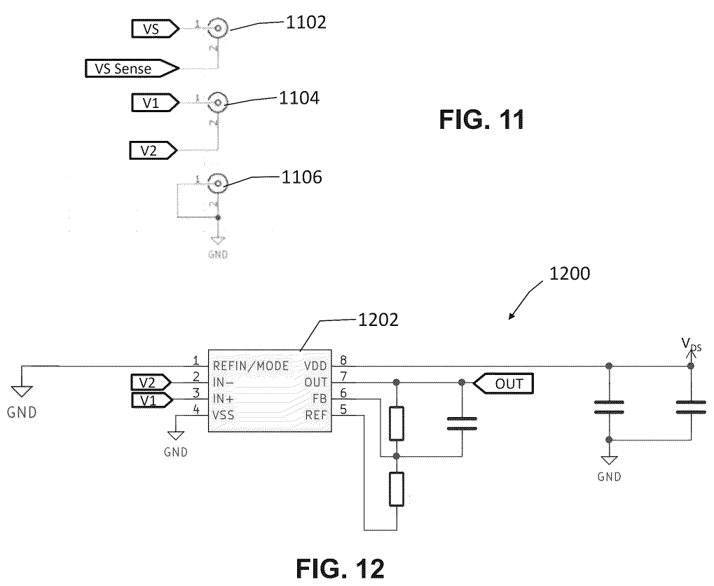

Turning to FIGS. 10-15, various circuits configured for measuring atmospheric resistive corrosion are depicted according to the disclosed technology. In particular, FIG. 10 is a high-level circuit representation of the atmospheric corrosion sensing electrode 500 shown in FIGS. 4-6. FIGS. 11-15 illustrate circuits for driving the sensing electrode 500 and measuring corrosion according to various implementations. It should be appreciated that these example circuits are only some of many possible examples useful for sensing and measuring changes in resistance on corrosion sensing electrodes according to the disclosed technology.

FIGS. 11-15 are diagrams of various circuits for driving a corrosion sensing electrode and measuring corrosion of the electrode according to various implementations. In various cases these circuits are located within a data logger or other instrumentation that connects to the corrosion sensing electrode through the electrode's connectors.

FIG. 11 depicts fourth, fifth, and sixth connectors or jacks 1102, 1104, 1106, for connecting to the supply connector, measurement connector, and ground connector, respectively, of the corrosion sensing electrode 500 shown in FIGS. 4-6 and 10. In various implementations the fourth jack 1102 is also used for sensing the level of the supply voltage V_{S} at the first node 130. FIG. 12 depicts an example of a measurement circuit 1200 including an instrumentation amplifier 1202 that receives the first and second voltage signals V₁ and V₂, determines the difference, and generates a corresponding output signal OUT.

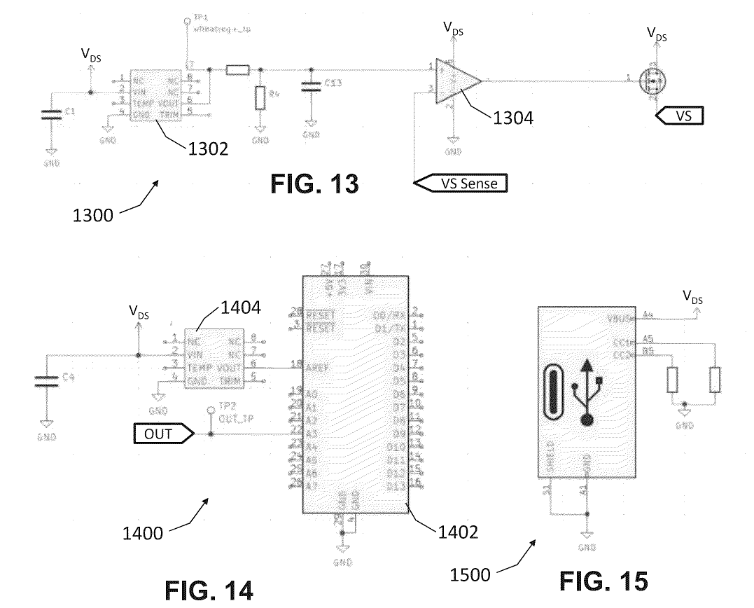

FIG. 13 depicts a driving circuit 1300 according to various implementations that generates the supply voltage V_{S} for powering the corrosion sensing electrode 500. In this example, the supply voltage V_{S} is derived from the supply voltage for the driving circuit 1300, Vos using a voltage regulator 1302 and a low-power precision operational amplifier 1304.

FIG. 14 is a processing circuit 1400 that receives and processes the difference output signal OUT from the measurement circuit of FIG. 12. In the depicted implementation, the processing circuit includes a hardware processor 1402 configured to analyze the output signal OUT and/or make various determinations based on the output signal. For example, the processor 1402 may in various cases be a microcontroller containing one or more processors and computer memories programmed with instructions for causing the one or more processors to carry out certain tasks. One possible example of a hardware processor is a microcontroller forming part of an Arduino Nano board. In various cases the processing circuit 1400 includes a voltage reference 1404 that the processor 1402 compares with the output signal OUT to determine changes in the output signal. In some cases the processor 1402 may be configured to determine changes in atmospheric corrosion of the sample material 102 on the sensing electrode 500 based on changes in the output signal OUT.

FIG. 15 is a power connection circuit 1500 for the sensor circuits shown in FIGS. 10-14. According to various implementations, the power connection circuit 1500 is electrically connected to a separate battery circuit (not shown). In some cases, the connection is a USB (e.g., Type C) connection. Of course, other configurations are also possible including for example, directly integrating the battery circuit with the sensor circuits on the same PCB.

Thus, it will be appreciated that implementations of the disclosed atmospheric corrosion sensor and electrode provide an effective way to detect and measure atmospheric corrosion. By using the Wheatstone bridge, this sensor is able to detect even the smallest changes in resistance caused by atmospheric corrosion. Further, the disclosed corrosion sensor technology improves upon past atmospheric corrosion techniques that are based on AC impedance measurements. Implementations of the disclosed technology include sensors that measure DC, which is far less complicated and sensitive to environmental factors than AC impedance and just as effective at detecting corrosion. Implementations of the sensor and electrode are also less complicated to construct, and the resulting measurements are more accurate than old AC impedance-based corrosion sensors.

Although the disclosure has been described with reference to certain implementations and embodiments, persons skilled in the art will recognize that changes may be made in form and detail without departing from the spirit and scope of the disclosed apparatus, systems and methods.

What is claimed is:

1. An atmospheric corrosion sensing electrode configured to removably connect with a data logger, the electrode comprising:
a corrosion circuit comprising:
a first leg comprising a first resistive component and a second resistive component in series; and
a second leg comprising a third resistive component and a sample material in series, the second leg parallel with the first leg;
a protective coating overlaying the first, second and third resistive components but not the sample material; and
at least one electrical connector configured to connect the corrosion sensing electrode to a data logger.

2. The electrode of claim 1, further comprising a printed circuit board, wherein each of the first, second, and third resistive components and the sample material comprises a conductive trace on the printed circuit board.

3. The electrode of claim 2, wherein the conductive trace of each of the first, second, and third resistive components and the sample material comprises a winding, interdigitated shape.

4. The electrode of claim 3, wherein each of the first, second, and third resistive components and the sample material comprises the same shape.

5. The electrode of claim 4, wherein the first and second resistive components are symmetrically arranged with the third resistive component and the sample material, respectively, about a first line, and wherein the first and third resistive components are symmetrically arranged with the second resistive component and the sample material, respectively, about a second line perpendicular to the first line.

6. The electrode of claim 1, wherein the sample material comprises steel.

7. The electrode of claim 1, wherein the at least one electrical connector comprises a plurality of conductors comprising:
a first conductor electrically coupled to the first and third resistive components;
a second conductor electrically coupled to second resistive component and the sample material;
a third conductor electrically coupled to the first leg between the sample material and the third resistive component; and
a fourth conductor electrically coupled to the second leg between the first resistive component and the third resistive component.

8. The electrode of claim 1, wherein the at least one electrical connector comprises a plurality of connectors comprising:
a first connector electrically coupled to the first and third resistive components;
a second connector electrically coupled to second resistive component and the sample material; and
a third connector comprising first and second conductors, the first conductor electrically coupled to the first leg between the sample material and the third resistive component, and the second conductor electrically coupled to the second leg between the first resistive component and the third resistive component.

9. The electrode of claim 1, wherein the corrosion circuit comprises a Wheatstone bridge.

10. The electrode of claim 1, wherein the corrosion circuit consists essentially of a Wheatstone bridge.

11. The electrode of claim 1, wherein the corrosion circuit consists of a Wheatstone bridge.

12. An atmospheric corrosion sensor comprising:
a data logger comprising an electrical connector and sensing circuitry; and
an atmospheric corrosion sensing electrode comprising:
a corrosion circuit comprising:
a first leg comprising a first resistive component and a second resistive component in series; and
a second leg comprising a third resistive component and a sample material in series, the second leg parallel with the first leg;
a protective coating overlaying the first, second and third resistive components but not the sample material; and
at least one electrical connector configured to connect the corrosion sensing electrode to the electrical connector of the data logger thereby connecting the corrosion circuit to the sensing circuitry.

13. The corrosion sensor of claim 12, wherein the sensing circuitry is configured to measure a voltage across the first leg and the second leg and determine a change in corrosion of the sample material based on the measured voltage.

14. The electrode of claim 12, further comprising a printed circuit board, wherein each of the first, second, and third resistive components and the sample material comprises a conductive trace on the printed circuit board.

15. The electrode of claim 14, wherein the conductive trace of each of the first, second, and third resistive components and the sample material comprises a winding, interdigitated shape.

16. The electrode of claim 15, wherein each of the first, second, and third resistive components and the sample material comprises the same shape.

17. The electrode of claim 16, wherein the first and second resistive components are symmetrically arranged with the third resistive component and the sample material, respectively, about a first line, and wherein the first and third resistive components are symmetrically arranged with the second resistive component and the sample material, respectively, about a second line perpendicular to the first line.

18. The corrosion sensor of claim 12, wherein the sample material comprises steel.

19. The corrosion sensor of claim 12, wherein the at least one electrical connector of the atmospheric corrosion sensing electrode comprises a plurality of conductors comprising:
a first conductor electrically coupled to the first and third resistive components;
a second conductor electrically coupled to second resistive component and the sample material;
a third conductor electrically coupled to the first leg between the sample material and the third resistive component; and
a fourth conductor electrically coupled to the second leg between the first resistive component and the third resistive component.

20. The corrosion sensor of claim 12, wherein the corrosion circuit comprises a Wheatstone bridge.
